(19) United States
(12) Patent Application Publication
(10) Pub. No.: US 2026/0242178 A1
(43) Pub. Date: Aug. 20, 2026

(54) PIT-SET ASSEMBLY FOR AN ELEVATOR SYSTEM AND A METHOD OF INSTALLATION THEREOF

(71) Applicant: INVENTIO AG, Hergiswil (CH)

(72) Inventors: Pradeep Kumbar, Maharashtra (IN); Alessandro D'Apice, Ebikon (CH); Romeo Lo Jacono, Gravesano (CH)

(21) Appl. No.: 19/472,359

(22) PCT Filed: Apr. 10, 2024
(86) PCT No.: PCT/EP2024/059749

§ 371 Date: Oct. 3, 2025

(30) Foreign Application Priority Data
Apr. 13, 2023 (EP) 23167723.8

(51) Int. Cl. B66B 7/02; B66B 19/00

(52) U.S. Cl. CPC B66B 7/025; B66B 19/00

(57) ABSTRACT

A pit-set assembly (102) for an elevator system is disclosed. The pit-set assembly (102) includes at least one pit platform (124) positioned in an elevator pit (100), and adapted to support a bottom end (122) of at least one guide rail (104-1, 104-2, 104′). Further, the pit-set assembly (102) includes at least one first support element (126-1, 126-2, 126′) mounted on the at least one pit platform (124), and adapted to abut a first face (116) of the bottom end (122). The pit-set assembly (102) includes at least one second support element (128-1, 128-2, 128′) mounted on the at least one pit platform (124), and adapted to abut a second face (118), preferably opposite to the first face (116), of the bottom end (122) of the at least one guide rail (104-1, 104-2, 104′). A position of the at least one second support element (128-1, 128-2, 128′) is adjusted, with respect to the at least one guide rail (104-1, 104-2, 104′), to abut the second face (118) of the bottom end (122).

The present invention relates to elevators, particularly to a pit-set assembly. The invention also relates to an elevator system having the pit-set assembly and a method of installation of the pit-set assembly in the elevator system.

Nowadays, elevators are an essential part of multi-story buildings, such as commercial buildings and residential buildings. In an elevator, a moving body, i.e., an elevator car or a counterweight, is typically displaced vertically along a travel path between different floors or levels within a structure, such as an elevator shaft. At least in tall buildings, the elevator car is held by rope or belt-like suspension elements and displaced within the elevator shaft by moving the suspension elements by means of a drive machine. In order to at least partially compensate for the load of the elevator car to be moved by the drive machine, the counterweight is usually attached to an opposite end of the suspension elements.

Typically, each moving body is guided by elevator rails which are often connected to at least one wall of the elevator shaft. The elevator rails are usually installed as multiple sections connected together from a bottom portion, such as an elevator pit, of the elevator shaft to a top portion of the elevator shaft. Each section may be connected to form an elevator rail extending along the elevator shaft. Generally, the elevator rails endure stress due to impact forces arising from braking or movement of the elevator car and/or the counterweight. Although, the elevator rails or multiple sections of the elevator rails are connected using brackets to the at least one wall, a lowest portion or a lowest section of the elevator rail may experience most of the stress induced due to the impact force. This results in twisting or bending of the elevator rails which might further hamper the overall operation of various sub-components, such as the elevator car, of the elevator. Also, such twisting or bending of the elevator rails substantially increases the overall maintenance cost of the elevator.

Currently, during the installation of the guide rails, firstly the guide rails at the lowest portion need to be manually positioned at a specific distance from each other and thereafter, the guide rails are connected using the brackets to the at least one wall. However, a measurement of the specific distance between the guide rails needs to be performed manually at the time of installing the guide rails. This results in labor-intensive and time-consuming installation process.

Therefore, there is a need for a provision that can be deployed for preventing twisting of the elevator rails and also to reduce the complexity of the installation process for the elevator rails and thereby, eliminate the abovementioned associated shortcomings.

It is in particular the object of the invention to submit a pit-set assembly for an elevator system. The pit-set assembly may be provided with support elements that are deployed to prevent the twisting or bending of a guide rail. Further, at least two support elements may be positioned at a specific distance which is required to install the guide rails spaced apart from each other by such distance. According to the invention, this object is solved by the pit-set assembly unit having the features of claim 1, an elevator system having the features of claim 16, and a method of installing the pit-set assembly having the features of claim 22.

The pit-set assembly for the elevator system is disclosed in the present invention. The pit-set assembly comprises at least one horizontal pit platform positioned in an elevator pit of an elevator shaft of the elevator system. The pit platform may lay flat on a horizontal upper surface of the elevator pit. The at least one pit platform is adapted to support a bottom end of at least one guide rail of the elevator system. Said at least one guide rail extends vertically through the elevator shaft. Further, the pit-set assembly comprises at least one first support element mounted on the at least one pit platform. The at least one first support element is adapted to abut a vertical first face of the bottom end of the at least one guide rail. The pit-set assembly comprises at least one second support element mounted on the at least one pit platform. The at least one second support element is adapted to abut a vertical second face, preferably opposite to the first face, of the bottom end of the at least one guide rail. A position of the at least one second support element is adjusted, with respect to the at least one guide rail, to abut the second face of the bottom end. Above directional information, i.e. the horizontal pit platform, the vertical first face and the vertical second face refer to a situation of the pit-set assembly when it is installed.

As explained, the at least one first support element and the at least one second support element may, when installed, abut the first face and the second face, respectively, of the at least one guide rail. Therefore, the bottom end of the at least one guide rail may be supported from more than one side to prevent twisting or bending of the at least one guide rail. Further, the at least one first support element and the at least one second support element may be mounted directly on the pit platform. This allows the pre-assembling of such support elements even before installing the pit-set assembly within the elevator pit. Therefore, after pre-assembling, the pit-set assembly can be installed within the elevator pit to support the bottom end without the requirement of installing any additional sub-component for supporting the bottom end of the at least one guide rail. This substantially reduces the overall time of installation and provides an easier installation process to support the bottom end of the at least one guide rail. Considering that both support elements are already mounted on the pit platform, the possibility of misplacing any such sub-components while installing or transporting the pit platform in the elevator pit is substantially eliminated.

Further, the support elements do not require any additional fastening components while supporting the bottom end of the at least one guide rail. In particular, the support elements do not need to be coupled to either the at least one guide rail or any other sub-component of the elevator system. As explained above, only the position of the at least one second support element may be adjusted, with respect to the at least one guide rail, to abut the second face of the bottom end and subsequently, tightened to such position for securing the at least one guide rail from the second face. This substantially reduces the manual labor involved during the installation process and thereby overall cost and time associated with such process are substantially reduced.

In an embodiment, the at least one first support element abuts the first face of the at least one guide rail to form a surface contact between one or more peripheral faces of the at least first support element and the first face. Further, the at least one second support element is adjusted to form a surface contact between the second face of the at least one guide rail and one or more peripheral faces of the at least second support element. The surface contact enables the at least one first support element and the at least one second support element to suitably support the bottom end from the first face and the second face, respectively, and thereby preventing twisting or bending of the at least one guide rail. In particular, the at least one first support element and the at least one second element are designed such that the surface contact forms between the respective face of the at least one guide rail provide sufficient support to restrict twisting or bending of the at least one guide rail.

In an embodiment, the at least one second support element comprises a plurality of elongated holes, each adapted to receive a fastening member and to allow lateral adjustment of the at least one second support element between a first position and a second position. Each elongated hole may be designed as an elliptical-shaped hole to allow lateral adjustment of the at least one support element over the pit platform with respect to the at least one guide rail.

In an embodiment, upon installation of the at least one guide rail, the at least one second support element is laterally adjusted to a position, between the first position and the second position, such that the at least one second support element abuts the second face of the at least one guide rail. Compared to the conventional arrangement, the at least one second support element needs to be mounted only on the pit platform and therefore, eliminates the requirement of connecting such support element to any other sub-components, such as walls or the at least one guide rail. In particular, the at least one second support element may be laterally adjusted, on the pit platform, to a position where such support element abuts the at least one guide rail and subsequently, fixed to the position on the pit platform. This reduces the overall installation time involved in supporting the bottom end of the at least one guide and also reduces the overall complexity of such an installation process.

In an embodiment, the plurality of elongated holes is oriented in a direction parallel to each other and inclined with respect to at least one peripheral face, of the at least one second support element, to be in contact with the at least one guide rail. Such an arrangement of the plurality of elongated holes may allow smooth adjustment of the at least one second support element by applying minimal force on such a second support element. This substantially reduces the overall physical effort required by installation personnel while supporting the bottom end of the at least one guide rail using the pit-set assembly.

In one or more embodiments, the pit-set assembly comprises a first pair of support elements having a first support element and a second support element mounted at a first end of the at least one pit platform. Further, the pit-set assembly comprises a second pair of support elements having a first support element and a second support element mounted at a second end of the at least one pit platform. The first support element and the first support element are mounted, on the at least one pit platform, at a predefined distance from each other, and each of the first pair of support elements and the second pair of support elements is adapted to support the bottom end of one of guide rails. Such positioning of first support elements may facilitate in installing the guide rails spaced apart from each other by the predefined distance D. The first support elements may be pre-assembled to the pit-set assembly before installing it within the elevator pit. Therefore, such predefined distance can be maintained at the time of pre-assembling the pit-set assembly. This reduces the overall time and effort required by the installation personnel for positioning the first support elements at the predefined distance after installing the pit-set assembly within the elevator pit.

In an embodiment, the pit-set assembly comprises at least one car buffer plate mounted on the at least one pit platform and adapted to support a first buffer unit for an elevator car. Further, the pit-set assembly comprises at least one counterweight buffer plate mounted on the at least one pit platform and adapted to support a second buffer unit for a counterweight.

In one or more embodiments, each of the at least one first support element and the at least one second support element has a plate-like structure. The advantage of using the plate-like structure is that owing to the simplicity of such a structure overall manufacturing cost can be substantially reduced. However, such structure of the at least one first support element and the at least one second support element should not be construed as limiting, and support elements with different structures can also be employed based on profile/cross-section of the at least one guide rail to be supported.

In one or more embodiments, the at least one first support element and the at least one second support element are formed as a singular plate-like structure. At least one advantage of using the singular plate-like structure is that overall manufacturing cost and installation time can be substantially reduced. In particular, both support elements can be manufactured at a same time as an integral component. This also eliminates the requirement of installing both support elements separately on the pit platform.

In one or more embodiments, each of the at least one first support element and the at least one second support element is formed of an alloy or a metallic material.

In one or more embodiments, a thickness of the at least one first support element is greater than a thickness of the at least one second support element.

In one or more embodiments, a thickness of the at least one first support element is less than a thickness of the at least one second support element.

In one or more embodiments, each of the at least one first support element and the at least one second support element comprises at least one flat surface adapted to facilitate positioning on a top surface of the at least one pit platform.

In one or more embodiments, the at least one pit platform is formed of a sheet metal. The use of sheet metal has the advantage that the at least one pit platform can be manufactured inexpensively and at a high quality. There is also a weight saving which simplifies the transport and installation of the at least one pit platform.

In one or more embodiments, the at least one pit platform is embodied as a structure having a U-shaped cross-section.

In one or more embodiments, the at least one pit platform comprises at least one bent edge adapted to be coupled to one or more structural elements of the elevator system. The object mentioned above is solved by an elevator system comprising at least one counterweight and at least one elevator car coupled to the at least one counterweight adapted to move within an elevator shaft having an elevator pit. Further, the elevator system comprises at least one guide rail extending along the elevator shaft and adapted to guide movement of the at least one counterweight and the at least one elevator car. Further, the elevator system comprises a pit-set assembly, according to any of the claims 1 to 15, positioned in the elevator pit and, adapted to support the at least one guide rail.

In one or more embodiments, the elevator system comprises at least one supporting bracket adapted to be coupled to a third face of the bottom end of the at least one guide rail. As mentioned earlier, the at least one guide rail is supported by the at least one first support element from the first face and by the at least one second support element from the second face. The at least supporting bracket may provide support to the at least guide rail from the third face. Therefore, at the bottom end, the at least one guide rail is supported from more than two sides which provide higher resistance to the impact forces and thereby, prevents twisting or bending of the at least one guide rail.

In one or more embodiments, the at least one guide rail is embodied as a hollow guide rail having a non-uniform cross-section bordered in a closed manner and defining at least three guide contours for guiding the at least one elevator car and the at least one counterweight.

In an embodiment, two guide contours are formed as a tongue and distant apart from each other defining the second face therebetween. Further, one guide contour is formed as a channel having the first face adapted to abut the at least one first support element mounted on the at least one pit platform.

In one or more embodiments, a profile of at least one peripheral face of the at least one first support element conforms with a profile of the channel at the bottom end of the at least one guide rail. The at least one first support element forms a form-fitting connection with the channel of the at least one guide rail. The advantage of the form-fitting connection is that a maximum surface contact may be achieved between the at least one first support element and the at least one guide rail. This substantially increases the overall resistance against the impact forces and thereby, the at least one first support element can optimally prevent the twisting or bending of the at least one guide rail. Further, a profile of the at least one peripheral face of the at least one second support element conforms with a profile of the second face of the bottom end of the at least one guide rail.

In one or more embodiments, the at least one guide rail is embodied as a guide rail having one of an I-shaped profile and a T-shaped profile.

The object mentioned above is solved by a method of installing the pit-set assembly, according to any of the claims 1-15, in an elevator system according to any of the claims 16-21. The method comprises positioning the pit-set assembly within the elevator pit. Further, the method comprises adjusting, upon installing the at least one guide rail, the at least one second support element with respect to the at least one guide rail to locate and abut at least the second face of the bottom end of the at least one guide rail, wherein the first face, preferably opposite to the second face, abuts the at least one first support element.

In an embodiment, the method comprises securing the at least one second support element to a position on the at least one pit platform when the at least one second support element abuts the at least one face of the at least one guide rail.

The term “first face” may be referred to a face of each guide rail, upon installation, preferably facing toward the elevator car.

The term “second face” may be referred to a face of each guide rail, upon installation, preferably facing toward the respective counterweight.

The term “third face” may be referred to as a face facing towards a front wall of the elevator shaft when each guide rail is positioned within the elevator shaft.

The term “front wall” may be referred to as a wall on which landing doors are located.

The term “lateral adjustment” may be referred to an adjustment of the second support element in a direction preferably parallel to the top surface of the at least one platform and towards one of the faces of the respective guide rail.

Additional advantages, features, and details of the invention result using the following description of exemplary embodiments and using drawings in which the same or functionally identical elements are provided having identical reference signs.

To further clarify advantages and features of the present invention, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

These and other features, aspects, and advantages of the present invention will become better understood when the following detailed description is read with reference to the accompanying drawings in which like characters represent like parts throughout the drawings, wherein:

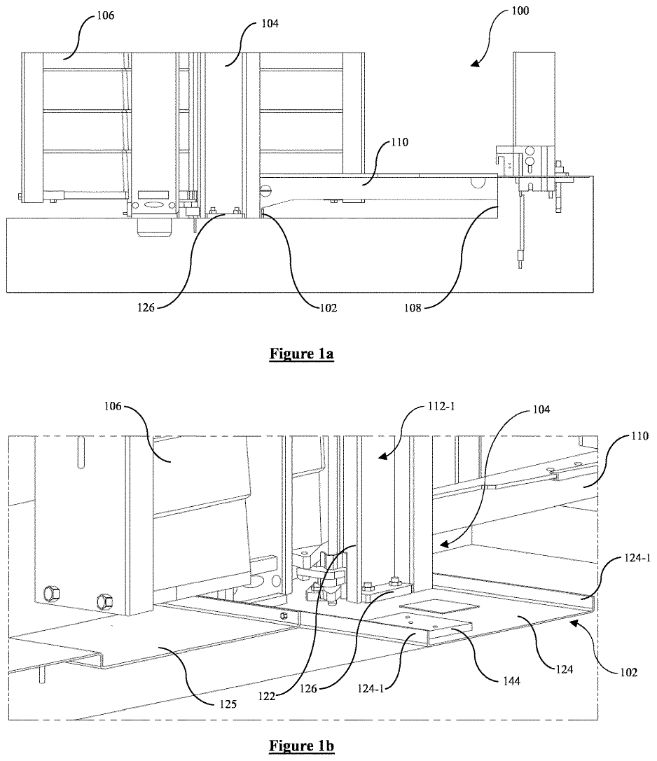

FIG. 1a illustrates a schematic view of an elevator pit of an elevator system depicting a pit-set assembly supporting at least one guide rail, according to an embodiment of the present invention;

FIGS. 1b-1d illustrate different perspective views of the elevator pit depicting the pit-set assembly positioned therein, according to an embodiment of the present invention;

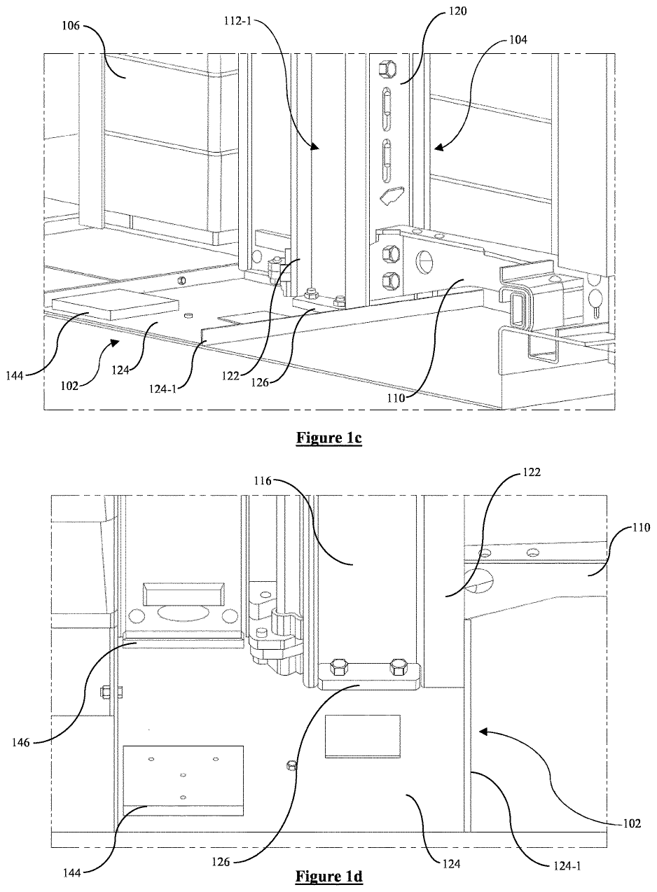

FIG. 2 illustrates an isometric view of the pit-set assembly, according to an embodiment of the present invention;

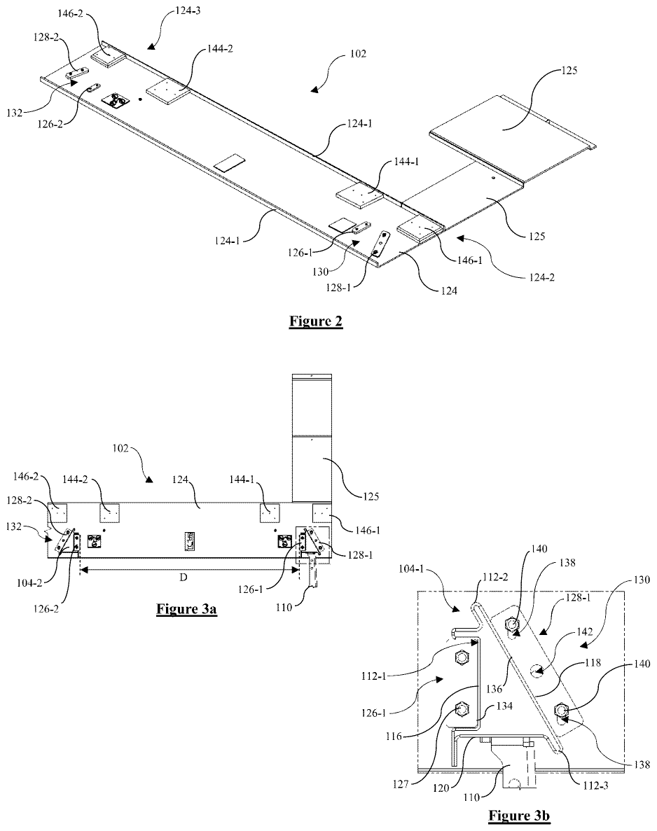

FIG. 3a illustrates a top view of the pit-set assembly, according to an embodiment of the present invention;

FIG. 3b illustrates a portion of the pit-set assembly depicting an arrangement of support elements, according to an embodiment of the present invention;

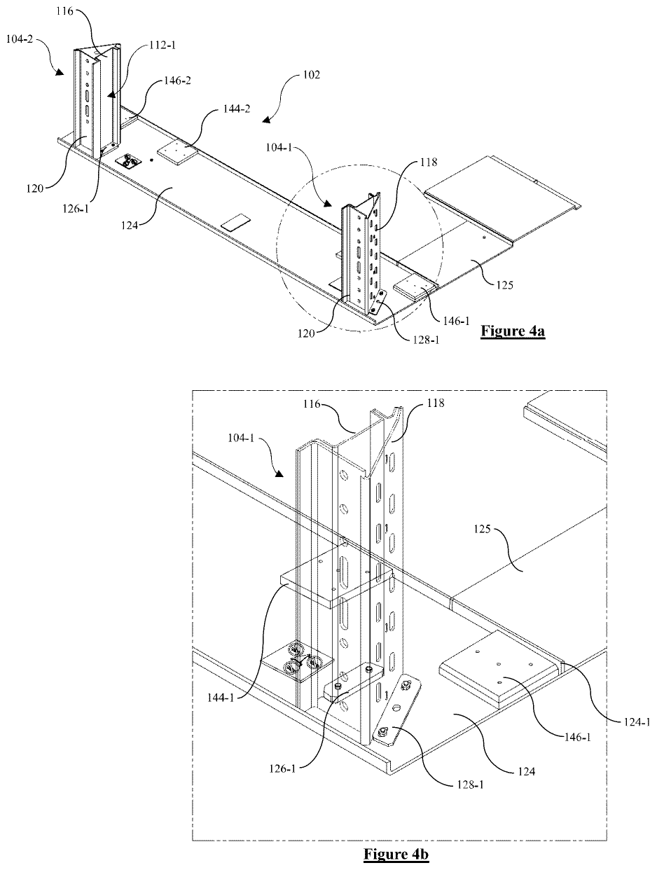

FIGS. 4a and 4b illustrate perspective views of the pit-set assembly depicting an arrangement the support elements with respect to guide rails, according to an embodiment of the present invention;

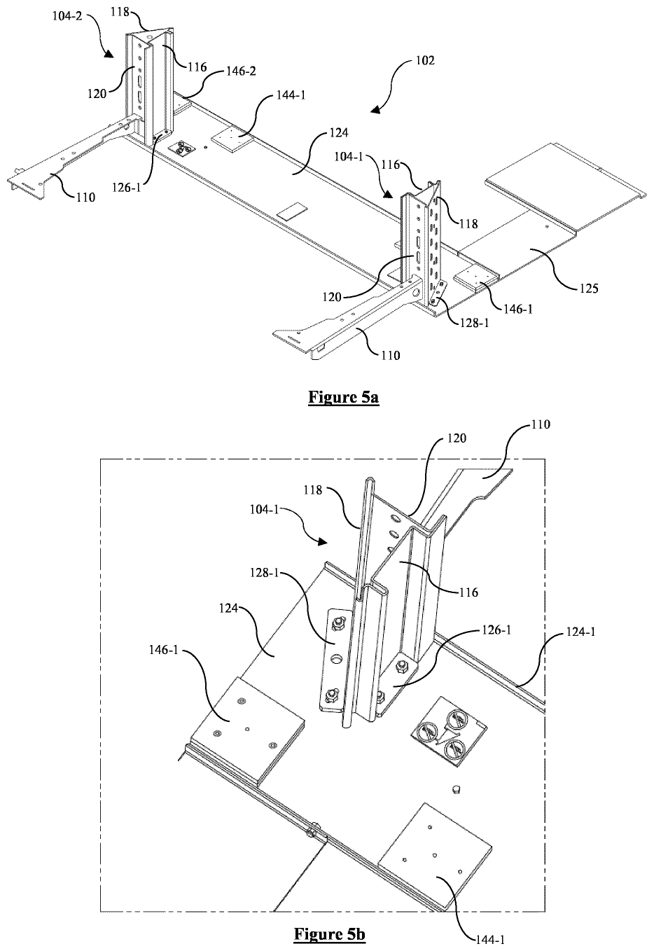

FIGS. 5a and 5b illustrate perspective views of the pit-set assembly depicting an arrangement the support elements with respect to the guide rails coupled to supporting brackets, according to an embodiment of the present invention; and

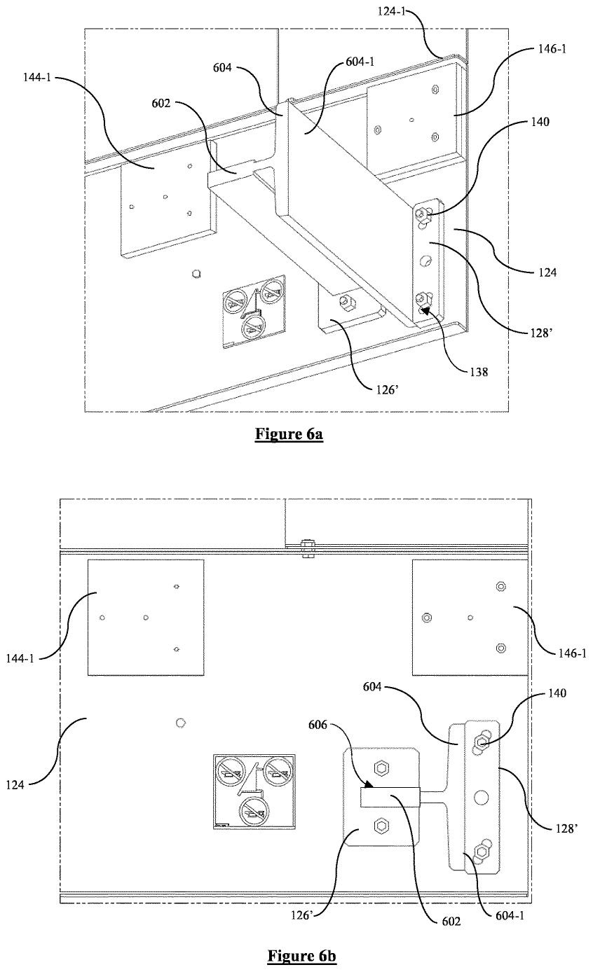

FIGS. 6a and 6b illustrate a perspective view and a top view, respectively, of the pit-set assembly depicting an arrangement of support elements with respect to a guide rail having a T-shaped profile, according to another embodiment of the present invention.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having benefit of the description herein.

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates. Unless otherwise defined, all technical and scientific terms used herein have the same meaning as commonly understood by one of ordinary skilled in the art to which this invention belongs. The system, methods, and examples provided herein are illustrative only and not intended to be limiting.

Any particular and all details set forth herein are used in the context of some embodiments and therefore should NOT be necessarily taken as limiting factors to the attached claims. The attached claims and their legal equivalents can be realized in the context of embodiments other than the ones used as illustrative examples in the description below.

Embodiments of the present invention will be described below in detail with reference to the accompanying drawings.

FIG. 1a illustrates a schematic view of an elevator pit 100 of an elevator system depicting a pit-set assembly 102 supporting at least one guide rail 104, according to an embodiment of the present invention. FIGS. 1b-1d illustrate different perspective views of the elevator pit 100 depicting the pit-set assembly 102 positioned therein, according to an embodiment of the present invention. The elevator system 100 may include, but is not limited to, the at least one guide rail 104, the pit-set assembly 102, at least one elevator car, and at least one counterweight 106.

The at least one guide rail 104 may be positioned within a vertical elevator shaft (not shown) and connected to at least one wall, such as a front wall 108, of the elevator shaft via supporting brackets 110. This guide rail extends vertically through the elevator shaft. The front wall 108 may be referred to as a wall on which landing doors are located. In an embodiment, the at least one vertical guide rail 104 may include, but is not limited to, a pair of guide rails 104-1, 104-2 connected to the front wall 108, of the elevator shaft, and horizontally spaced apart from each other. The pair of guide rails 104-1, 104-2 may interchangeably be referred to as the guide rails 104-1, 104-2, without departing from the scope of the present invention.

In the illustrated embodiment, each of the guide rails 104-1, 104-2 may be embodied as a hollow guide rail having a non-uniform cross-section bordered in a closed manner and defining at least three guide contours 112 for guiding the at least one elevator car and the at least one counterweight 106. One guide contour 112-1 may be formed as a channel having a vertical first face 116. In an embodiment, the term “channel” may be referred to as U-shaped channel having a continuous bottom and two side surfaces protruding the continuous bottom. The continuous bottom and two side surfaces collectively define the first face 116. Further, two guide contours 112-2, 112-3 of each guide rail 104 may be formed as a tongue and distant apart from each other defining a vertical second face 118 therebetween.

As explained earlier, each guide rail 104-1, 104-2 may be connected to the front wall 108 of the elevator shaft via the supporting brackets 110. Each supporting bracket 110 may be adapted to be coupled to a third face 120 of each guide rail 104 and the front wall. In an embodiment, the term “third face” may be referred to as a face facing towards the front wall 108 of the elevator shaft when each guide rail 104-1, 104-2 is positioned within the elevator shaft.

The at least one elevator car may be adapted to be guided by the guide rails 104-1, 104-2 within the elevator shaft between a plurality of floors of a building. In an embodiment, guide shoes (not shown) of the at least one elevator car may be engaged with the guide contour 112-1 of the guide rails 104-1, 104-2 to allow movement of the at least one elevator car. The at least one counterweight 106 may be adapted to counterbalance a sum of a load of the at least one elevator car and a predetermined load associated with a payload capacity of the at least one elevator car.

In an embodiment, the elevator system may include at least a pair of counterweights, such as 106, disposed on either sides of the at least one elevator car. Each counterweight 106 may be movably coupled to the at least one elevator car via traction members (not shown) and, adapted to be guided on a respective guide rail, such as 104-1, 104-2. In an embodiment, guide shoes of each counterweight 106 may be engaged with the guide contours 112-2, 112-3 of the respective guide rail, such as 104-1, 104-2.

Referring to FIGS. 1a-1d, each guide rail 104-1, 104-2 may be positioned within the elevator shaft upon mounting the pit-set assembly 102 in the elevator pit 100. Each guide rail 104-1, 104-2 may vertically extend along the elevator shaft such that a bottom end 122 of each guide rail 104-1, 104-2 is located within the elevator pit 100. The bottom end 122 of each guide rail 104-1, 104-2 may be positioned above the pit-set assembly 102. In an embodiment, the pit-set assembly 102 may be adapted to support the bottom end 122 of each guide rail 104-1, 104-2. The pit-set assembly 102 may be adapted to restrict the twisting of each guide rail 104-1, 104-2 during the operation of the elevator system. The term “twisting” refers to a bending of the bottom end 122 of each guide rail 104-1, 104-2 due to forces acting upon the bottom end 122 during movement or operations, such as braking, of the at least one elevator car and the counterweights 106 on each guide rail 104-1, 104-2.

Constructional and operational details of the pit-set assembly 102 are explained in detail with respect to the description of FIGS. 2-6b.

FIG. 2 illustrates an isometric view of the pit-set assembly 102, according to an embodiment of the present invention. FIG. 3a illustrates a top view of the pit-set assembly 102, according to an embodiment of the present invention. FIG. 3b illustrates a portion of the pit-set assembly 102 depicting an arrangement of support elements, according to an embodiment of the present invention. The pit-set assembly 102 may include, but is not limited to, at least one pit platform 124, at least one first support element 126, at least one second support element 128. The pit-set assembly 102 and especially its pit platform 124 preferably lies on a horizontal upper surface of the elevator pit 100.

The at least one horizontal pit platform 124 may be positioned in the elevator pit 100 of the elevator system, and adapted to support the bottom end 122 of each guide rail 104-1, 104-2 of the elevator system. The at least one pit platform 124 may interchangeably be referred to as the pit platform 124, without departing from the scope of the present disclosure. The pit platform 124 or at least parts of the pit platform 124 may be formed of a sheet metal. In an embodiment, the sheet metal may preferably be brought into a shape of the pit platform 124 or the parts thereof by a rolling process, without departing from the scope of the present invention.

In an embodiment, the pit platform 124 may be embodied as a structure having a U-shaped cross-section. In such an embodiment, the pit platform 124 may include, but is not limited to, at least one bent edge 124-1 adapted to be coupled to one or more structural elements 125 of the elevator system. In an embodiment, the one or more structural elements 125 may be fastened to the at least one bent edge 124-1 of the pit platform 124 using fasteners, such as screws and bolts. In one embodiment, the one or more structural elements 125 may be embodied as a platform formed of a sheet metal and adapted to support various sub-components, such as height adjustment devices, of the elevator system. In another embodiment, the one or more structural elements 125 may be embodied as an intermediate platform for connecting adjacent platforms, to support various sub-components, with the pit platform 124.

FIGS. 4a and 4b illustrate perspective views of the pit-set assembly 102 depicting an arrangement of support elements with respect to the guide rails 104-1, 104-2, according to an embodiment of the present invention. FIGS. 5a and 5b illustrate perspective views of the pit-set assembly 102 depicting an arrangement the support elements with respect to the guide rails 104-1, 104-2 coupled to supporting brackets 110, according to an embodiment of the present invention. The pit-set assembly 102 may include the support elements, such as the at least one first support element 126 and the at least one second support elements 128, adapted to support the bottom end 122 of each guide rail 104-1, 104-2 on the pit platform 124. The support elements 126, 128 may be adapted to restrict twisting of the bottom end 122 of each guide rail 104-1, 104-2.

In the illustrated embodiment, the pit-set assembly 102 may include, but is not limited to, a first pair of support elements 130 and a second pair of support elements 132. The first pair of support elements 130 may be adapted to support the bottom end 122 of the guide rail 104-1. Similarly, the second pair of support elements 132 may be adapted to support the bottom end 122 of the guide rail 104-2. The first pair of support elements 130 may include a first support element 126-1 and a second support element 128-1 mounted at a first end 124-2 of the pit platform 124. Similarly, the second pair of support elements 132 may include a first support element 126-2 and a second support element 128-2 mounted at a second end 124-3 of the pit platform 124.

The first support element 126-1 and the first support element 126-2 may be mounted, on the pit platform 124, at a predefined distance D from each other. Such positioning of first support elements 126-1, 126-2 may facilitate in installing the guide rails 104-1, 104-2 spaced apart from each other by the predefined distance D. In an embodiment, the predefined distance D may be defined as a track width for the elevator car, i.e., the distance between guide contours used to guide the elevator car.

In an embodiment, each first support element may be fastened to the pit platform using fasteners 127, such as bolts and/or screws. In an embodiment, the first support elements 126-1, 126-2 may be mounted on the pit platform 124 during a pre-assembling process of the pit-set assembly 102. The term “pre-assembling process” may be referred to an assembling process of various sub-components, such as the support elements 126, 128 and the pit platform 124, of the pit-set assembly 102 before mounting the pit-set assembly 102 within the elevator pit 100. In an embodiment, each first support element 126-1, 126-2 may include at least one flat surface adapted to facilitate positioning on a top surface of the pit platform 124. The at least one flat surface may be referred to as a bottom surface when each first support element 126-1, 126-2 is positioned on the pit platform 124.

The at least one first support element 126-1, 126-2 may be adapted to abut the first face 116 of the bottom end 122 of the at least one guide rail 104-1, 104-2. In the illustrated embodiment, the first support element 126-1 may abut the first face 116 of the guide rail 104-1 and the first support element 126-2 may abut the first face 116 of the guide rail 104-2. As explained earlier, the pit-set assembly 102 may be mounted in the elevator pit 100 before installing the guide rails 104-1, 104-2 in the elevator shaft. The guide rails 104-1, 104-2 may be installed in the elevator shaft in such a manner that the first face 116 of each guide rail 104-1, 104-2 abuts a respective support element, such as 126-1, 126-2, mounted on the pit platform 124.

Each first support element 126-1, 126-2 may be formed of an alloy or a metallic material. In an embodiment, each first support element 126-1, 126-2 may have a plate-like structure. Each first support element 126-1, 126-2 may have a thickness to facilitate a surface contact with the first face 116 of the respective guide rail, such as 104-1, 104-2. Each first support element 126-1, 126-2 may abut the first face 116 of the respective guide rail 104-1, 104-2 to form a surface contact between one or more peripheral faces 134 of each first support element 126-1, 126-2 and the first face 116 of the respective guide rail 104-1, 104-2. In an embodiment, a profile of the peripheral faces 134 of each first support element 126-1, 126-2 conforms with a profile of the channel, i.e., the guide contour 112-1, at the bottom end 122 of the respective guide rail 104-1, 104-2. Each first support element 126-1, 126-2 may form a form-fitting connection with the channel of the respective guide rail 104-1, 104-2.

Further, each second support element 128-1, 128-2 may be mounted on the pit platform 124. In an embodiment, each second support element 128-1, 128-2 may be mounted on the pit platform 124 during the pre-assembling process of the pit-set assembly 102. Each second support element 128-1, 128-2 may be adapted to abut the second face 118, preferably opposite to the first face 116, of the bottom end 122 of the respective guide rail 104-1, 104-2. In an embodiment, each second support element 128-1, 128-2 may include at least one flat surface adapted to facilitate positioning on the top surface of the pit platform 124. The at least one flat surface may be referred to as a bottom surface when each second support element 128-1, 128-2 is positioned on the pit platform 124.

Each second support element 128-1, 128-2 may be formed of an alloy or a metallic material. In an embodiment, each second support element 128-1, 128-2 may have a plate-like structure. Each second support element 128-1, 128-2 may have a thickness to facilitate a surface contact with the second face 118 of the respective guide rail, such as 104-1, 104-2. In one embodiment, the thickness of each first support element 126-1, 126-2 may be greater than the thickness of each second support element 128-1, 128-2. In another embodiment, the thickness of each first support element 126-1, 126-2 may be less than a thickness of each second support element 128-1, 128-2.

Each second support element 128-1, 128-2 may be adjustably mounted on the pit platform. A position of each second support element 128-2, 128-2 may be adjusted, with respect to the respective guide rail 104-1, 104-2, to abut the second face 118 of the bottom end 122. Each second support element 128-1, 128-2 may be adjusted to form the surface contact between the second face 118 of the respective guide rail 128-1, 128-2 and one or more peripheral faces 136 of each second support element 128-1, 128-2. In an embodiment, a profile of the one or more peripheral faces 136 of each second support element 128-1, 128-2 may conform with a profile of the second face 118 of the bottom end 122 of the respective guide rail 104-1, 104-2.

Each second support element 128-1, 128-2 may include, but is not limited to, a plurality of elongated holes 138 (as shown in FIG. 3b). The plurality of elongated holes 138 may be oriented in a direction parallel to each other and inclined with respect to at least one peripheral face 136, of the respective second support element 128-1, 128-2, to be in contact with the respective guide rail 104-1, 104-2.

Each elongated hole 138 may be adapted to receive a fastening member 140 and to allow lateral adjustment of the respective second support element 128-1, 128-2 between a first position and a second position. Each elongated hole 138 may be embodied as an elliptical-shaped hole having a first end and a second end distal to the first end. The first position may be referred to as a position in which the fastening member 140 may coincide with the first end of each elongated hole 138. Further, the second position may be referred to as a position in which the fastening member 140 may coincide with the second end of each elongated hole 138.

In an embodiment, a length of each elongated hole 138 may be defined between the first end and the second end. A maximum distance of adjustment of each second support element 128-1, 128-2 may depend on the length of the elongated holes 138 of the respective second support element 128-1, 128-2. Each second support element 128-1, 128-2 may be mounted on the pit platform 124 in a manner that each second support element 128-1, 128-2 can be adjusted in a direction parallel to the length of the elongated holes 138.

Further, each second support element 128-1, 128-2 may include an engaging hole 142 to facilitate adjustment of each second support element 128-1, 128-2 with respect to the respective guide rail 104-1, 104-2. In an embodiment, a tool, such as a screwdriver, may be used to adjust the position of each second support element 128-1, 128-2 via the engaging hole 142. In such an embodiment, the tool may be engaged with the engaging hole 142 and subsequently pulled towards the respective guide rail 104-1, 104-2 to ensure the surface contact between each support element 128-1, 128-2 and the respective guide rail 104-1, 104-2.

Upon installation of the guide rails 104-1, 104-2, each second support element 128-1, 128-2 may be laterally adjusted to a position, between the first position and the second position, such that each second support element 128-1, 128-2 abuts the second face of the respective guide rail 104-1, 104-2. As explained earlier, the guide rails 104-1, 104-2 may be installed such that, initially, the bottom end 122 of each guide rail 104-1, 104-2 abuts the respective first support element 126-1, 126-2. Subsequently, each second support element 128-1, 128-2 may be pulled from the first position towards the second face 118 of the respective guide rail 104-1, 104-2. The fastening member 140 may be adapted to be tightened to secure each second support element 128-1, 128-2 to the position between the first position and the second position, when each second support element 128-1, 128-2 abuts the second face 118 of the respective guide rail 104-1, 104-2.

In an embodiment, each first support element 126-1, 126-2 and each second support element 128-1, 128-2 may be formed as a singular plate-like structure. In such an embodiment, the first support element 126-1 and the second support element may be formed as an integral part having a plate-like structure. Similarly, the first support element 126-2 and the second support element 128-2 may be formed as an integral part having a plate-like structure. In one embodiment, the singular plate-like structure may be designed in a V-shape and mounted on the pit platform 124. In such an embodiment, each guide rail 104-1, 104-2 may be positioned in such a way that the bottom end 122 of each guide rail 104-1, 104-2 falls between the respective first support element 126-1, 126-2 and the respective second support element 128-1, 128-2 of the singular plate-like structure. In another embodiment, the singular plate-like structure may be designed in such a way that each second support element 128-1, 128-2 may be pivotally connected to the respective first support element 126-1, 126-2. In such an embodiment, each second support element 128-1, 128-2 may be adjusted to abut the second face 118 of the respective guide rail 104-1, 104-2.

Further, the pit-set assembly 102 may include, but is not limited to, at least one car buffer plate 144 and at least one counterweight buffer plate 146. The at least one car buffer plate 144 may be mounted on the pit platform 124 and adapted to support a first buffer unit (not shown) for the elevator car. In the illustrated embodiment, a first buffer plate 144-1 may be mounted adjacent to the first end 124-2 of the pit platform 124 and a second buffer plate 144-2 may be mounted adjacent to the second end 124-3 of the pit platform 124.

The at least one counterweight buffer plate 146 may be mounted on the pit platform 124 and adapted to support a second buffer unit (not shown) for the counterweight 106. In an embodiment, a first counterweight buffer plate 146-1 may be mounted at the first end 124-2 of the pit platform 124 and a second counterweight buffer 146-2 plate may be mounted at the second end 124-3 of the pit platform 124. In an embodiment, a plurality of counterweight buffer plates 146 may be stacked over each other and mounted on the pit platform 124 to support the second buffer unit.

Although the present invention is explained with respect to the hollow guide rails having a non-uniform cross-section. However, this should not be construed as limiting as the present invention is equally applicable for solid guide rails having T-shaped or I-shaped profiles, without departing from the scope of the present invention. Implementation of the pit-set assembly 102 with respect to one of such solid guide rails is explained with respect to the description of FIGS. 6a and 6b.

FIGS. 6a and 6b illustrate a perspective view and a top view, respectively, of the pit-set assembly 102 depicting an arrangement of support elements with respect to a guide rail 104′ having a T-shaped profile or a T-shaped cross-section, according to another embodiment of the present invention. Referring to FIGS. 6a and 6b, each T-shaped guide rail 104′ may include, but is not limited to a flange portion 602 perpendicularly oriented to a web portion 604. The flange portion 602 and the web portion 604 may collectively define the T-shaped profile or the T-shaped cross-section. The web portion 604 may define one guide contour to guide at least one of guide shoes of the elevator car. Further, the flange portion 602 may define two guide contours for guiding one of the counterweights 106.

In the illustrated embodiment, the pit-set assembly 102 may support a bottom end 122′ of each T-shaped guide rail 104′. The pit-set assembly 102 may include at least one first support element 126′ and at least one second support element 128′. The first support element 126′ may be mounted on the pit platform 124 and adapted to form a form-fitting connection with the flange portion 602 of each T-shaped guide rail 104′. Referring to FIG. 6b, the first support element 126′ may include an engaging portion 606 having a U-shaped profile. The engaging portion 606 may be adapted to receive the flange portion 602 of each T-shaped guide rail 104′ and, subsequently forms a surface contact therebetween. A profile of peripheral surfaces of the engaging portion 606 conforms with a profile of the flange portion 602 of each T-shaped guide rail 104′.

The second support element 128′ may be mounted on the pit platform 124 and adapted to be adjusted to abut at least one surface 604-1 of the web portion 604 of each T-shaped guide rail 104′. Further, similar to each second support element 128-1, 128-2, the second support element 128′ may include the elongated holes 138, each adapted to receive the fastening member 140 and to allow lateral adjustment of the second support element 128′ between the first position and the second position. Upon installation of the T-shaped guide rail 104′, the second support element 128′ may be laterally adjusted to a position, between the first position and the second position, such that the second support element 128′ abuts the at least one surface 604-1 of the web portion 604.

With the understanding of the structure of the pit-set assembly 102 and the functionalities of its components described with respect to the description of FIGS. 1a-6b, at least one embodiment of a method of installing the pit-set assembly is described in the subsequent sections of the present invention. For the sake of brevity, features of the pit-set assembly 102 that are already explained in detail in the description of Figures la-6b are not explained in detail in the subsequent sections.

In an embodiment, at a first step, the method may include positioning the pit-set assembly 102 within the elevator pit 100. The pit-set assembly 100 may be positioned in the elevator pit 100 after the pre-assembling process which includes at least fastening of each first support element 126-1, 126-2 and each second support element 128-1, 128-2 to the pit platform 124 of the pit-set assembly 102. The pit-set assembly 102 may be positioned in the elevator pit 100 and subsequently fixed to a floor of the elevator pit 100.

At a subsequent step, the method may include adjusting, upon installing the each guide rail 104-1, 104-2, each second support element 128-1, 128-2 with respect to the respective guide rail 104-1, 104-2 to locate and abut at least the second face 118 of the bottom end 122 of the respective guide rail 104-1, 104-2. The first face 116, preferably opposite to the second face 118, abuts the respective first support element 126-1, 126-2. In the present step, initially, each guide rail 104-1, 104-2 may be installed such that the first face 116 of each guide rail 104-1, 104-2 may abut the respective first support element 126-1, 126-2. Subsequently, each second support element 128-1, 128-2 may be adjusted to form the surface contact with the second face 118 of the respective guide rail 104-1, 104-2. In an embodiment, each second support element 128-1, 128-2 may be pulled towards the second face 118 of the respective guide rail 104-1, 104-2 using the tool as explained earlier.

Further, at a subsequent step, the method may include securing each second support element 128-1, 128-2 to a position on the pit platform 124 when each second support element 128-1, 128-2 abuts at least one face, such as the second face 118, of the respective guide rail 104-1, 104-2. The fastener 140 may be tightened to secure each second support element 128-1, 128-2 to the position in which the second face 118 of each guide rail 104-1, 104-2 forms the surface contact with the respective second support element 128-1, 128-2.

While specific language has been used to describe the present subject matter, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

1.-23. (canceled)

24. A pit-set assembly for an elevator system, the pit-set assembly comprising:
at least one pit platform positioned in an elevator pit of the elevator system, wherein the at least one pit platform supports a bottom end of at least one guide rail of the elevator system;
at least one first support element mounted on the at least one pit platform, wherein the at least one first support element abuts a vertical first face of the bottom end of the at least one guide rail; and
at least one second support element mounted on the at least one pit platform, wherein the at least one second support element abuts a vertical second face, opposite to the first face, of the bottom end of the at least one guide rail, and wherein a position of the at least one second support element is adjusted, with respect to the at least one guide rail, to abut the second face of the bottom end.

25. The pit-set assembly according to claim 24, wherein the at least one first support element abuts the first face of the at least one guide rail to form a surface contact between one or more peripheral faces of the at least one first support element and the first face, and the at least one second support element is adjusted to form a surface contact between the second face of the at least one guide rail and one or more peripheral faces of the at least second support element.

26. The pit-set assembly according to claim 24, wherein the at least one second support element comprises a plurality of elongated holes, and wherein each of the elongated holes receives a fastening member and allows lateral adjustment of the at least one second support element between a first position and a second position.

27. The pit-set assembly according to claim 26, wherein, upon installation of the at least one guide rail, the at least one second support element is laterally adjusted to a position, between the first position and the second position, such that the at least one second support element abuts the second face of the at least one guide rail.

28. The pit-set assembly according to claim 26, wherein the plurality of elongated holes is oriented in a direction parallel to each other and inclined with respect to at least one peripheral face of the at least one second support element to be in contact with the at least one guide rail.

29. The pit-set assembly according to claim 24, further comprising:
a first pair of support elements having a first support element and a second support element mounted at a first end of the at least one pit platform; and
a second pair of support elements having a first support element and a second support element mounted at a second end of the at least one pit platform, wherein the first support element and the second support element of each pair of support elements are mounted on the at least one pit platform at a predefined distance (D) from each other, and each of the first pair of support elements and the second pair of support elements supports the bottom end of one of guide rails.

30. The pit-set assembly according to claim 24, further comprising:
at least one car buffer plate mounted on the at least one pit platform, wherein the at least one car buffer plate supports a first buffer unit for an elevator car; and
at least one counterweight buffer plate mounted on the at least one pit platform, wherein the at least one counterweight buffer plate supports a second buffer unit for a counterweight.

31. The pit-set assembly according to claim 24, wherein each of the at least one first support element and the at least one second support element has a plate-like structure and/or is formed of an alloy or a metallic material.

32. The pit-set assembly according to claim 24, wherein the at least one first support element and the at least one second support element are formed as a singular plate-like structure.

33. The pit-set assembly according to claim 24, wherein a thickness of the at least one first support element is greater than a thickness of the at least one second support element; or wherein a thickness of the at least one first support element is less than a thickness of the at least one second support element.

34. The pit-set assembly according to claim 24, wherein each of the at least one first support element and the at least one second support element comprises at least one flat surface to facilitate positioning on a top surface of the at least one pit platform.

35. The pit-set assembly according to claim 24, wherein the at least one pit platform is at least one of: formed of a sheet metal; embodied as a structure having a U-shaped cross-section; and/or includes at least one bent edge coupled to one or more structural elements of the elevator system.

36. An elevator system comprising:
at least one counterweight;
at least one elevator car coupled to the at least one counterweight, wherein the at least one elevator car moves within an elevator shaft having an elevator pit;
at least one guide rail extending along the elevator shaft, wherein the at least one guide rail guides movement of the at least one counterweight and the at least one elevator car; and
a pit-set assembly positioned in the elevator pit, wherein the pit-set assembly supports the at least one guide rail, the pit-set assembly including:
at least one pit platform positioned in the elevator pit, wherein the at least one pit platform supports a bottom end of the at least one guide rail;
at least one first support element mounted on the at least one pit platform, wherein the at least one first support element abuts a vertical first face of the bottom end of the at least one guide rail; and
at least one second support element mounted on the at least one pit platform, wherein the at least one second support element abuts a vertical second face, opposite to the first face, of the bottom end of the at least one guide rail, and wherein a position of the at least one second support element is adjusted, with respect to the at least one guide rail, to abut the second face of the bottom end.

37. The elevator system according to claim 36, further comprising at least one supporting bracket coupled to a third face of the bottom end of the at least one guide rail.

38. The elevator system according to claim 36, wherein the at least one guide rail is embodied as a hollow guide rail having a non-uniform cross-section bordered in a closed manner and defining at least three guide contours for guiding the at least one elevator car and the at least one counterweight.

39. The elevator system according to claim 38, wherein two guide contours are formed as a tongue and distant apart from each other defining the second face therebetween, and wherein one guide contour is formed as a channel having the first face abut the at least one first support element mounted on the at least one pit platform.

40. The elevator system according to claim 36, wherein a profile of at least one peripheral face of the at least one first support element conforms with a profile of the channel at the bottom end of the at least one guide rail, wherein the at least one first support element forms a form-fitting connection with the channel of the at least one guide rail, and wherein a profile of the at least one peripheral face of the at least one second support element conforms with a profile of the second face of the bottom end of the at least one guide rail.

41. The elevator system according to claim 36, wherein the at least one guide rail is embodied as a guide rail having one of an I-shaped profile and a T-shaped profile.

42. A method of installing a pit-set assembly in an elevator system, the method comprising:
positioning a pit-set assembly within an elevator pit, the pit-set assembly including:
at least one pit platform positioned in the elevator pit, wherein the at least one pit platform supports a bottom end of at least one guide rail extending along an elevator shaft;
at least one first support element mounted on the at least one pit platform, wherein the at least one first support element abuts a vertical first face of the bottom end of the at least one guide rail; and
at least one second support element mounted on the at least one pit platform, wherein the at least one second support element abuts a vertical second face, opposite to the first face, of the bottom end of the at least one guide rail; and
adjusting, upon installing the at least one guide rail, the at least one second support element with respect to the at least one guide rail to locate and abut at least the second face of the bottom end of the at least one guide rail, wherein the first face, opposite to the second face, abuts the at least one first support element.

43. The method according to claim 42, further comprising securing the at least one second support element to a position on the at least one pit platform when the at least one second support element abuts the at least one face of the at least one guide rail.
